(19) United States
(12) Patent Application Publication
(10) Pub. No.: US 2005/0133103 A1
(43) Pub. Date: Jun. 23, 2005

(54) Three way coupler having adjusting device

(76) Inventor: Chun Po Huang, Taichung (TW)

Correspondence Address: Charles E. Baxley, ESQ., 90 John Street 3rd Floor, New York, NY, 10038, US

(21) Appl. No.: 10/744,399

(22) Filed: Dec. 19, 2003

(51) Int. Cl. F16K 11/22

(52) U.S. Cl. 137/887

(57) ABSTRACT

A three way coupler includes a housing having a bore to receive fluid, and having two ends for coupling to pipes, and having an orifice communicating with the bore of the housing. A barrel is secured to the housing and includes a hole communicating with the bore of the housing. An adjusting device includes a shank rotatably engaged into the orifice of the housing, and having a passage to selectively align with the bore of the housing, and to adjust a flowing of the fluid through the bore of the housing. Another adjusting device may be attached to the barrel, to adjust a flowing of the fluid through the hole of the barrel.

### BACKGROUND OF THE INVENTION

1. Field of the Invention

The present invention relates to a three way valve or coupler, and more particularly to a three way coupler having one or more adjusting devices for adjusting the flowing of fluids.

2. Description of the Prior Art

Various kinds of typical power tools or spraying nozzles or the like are required to be coupled to pneumatic or hydraulic power driving apparatuses via the conduits or pipes, for allowing the power tools and/or the spraying nozzles or the like to be driven or operated by the pneumatic or hydraulic power driving apparatuses.

Normally, the spraying nozzles and the power tools are directly coupled to the pneumatic or hydraulic power driving apparatuses, and are required to be changeably coupled to the pneumatic or hydraulic power driving apparatuses frequently, and may not be simultaneously coupled to the pneumatic or hydraulic power driving apparatuses.

Various kinds of typical three way couplers have been developed and comprise three ports for coupling to various conduits or pipes. For example, U.S. Pat. No. 3,974,848 to Wheatley and U.S. Pat. No. 5,383,485 to Lai disclose two of the typical three way couplers each includes three ports for coupling to various conduits or pipes, and one or more valve members disposed in the three way couplers, for controlling the flowing of the air or fluid through the ports of the couplers.

However, the typical three way couplers have not designed for and may not be provided for coupling various power tools or spraying nozzles or the like to the pneumatic or hydraulic power driving apparatuses.

In addition, the typical three way couplers do not include or provide any adjusting devices for adjusting the flowing of the air or fluid through the ports of the couplers.

The present invention has arisen to mitigate and/or obviate the afore-described disadvantages of the conventional three way couplers.

### SUMMARY OF THE INVENTION

The primary objective of the present invention is to provide a three way coupler for simultaneously coupling two or more power tools and/or spraying nozzles or the like to pneumatic or hydraulic power driving apparatuses.

The other objective of the present invention is to provide a three way coupler including one or more adjusting devices for adjusting the flowing of air or fluid through the conduits or pipes of the pneumatic or hydraulic power driving apparatuses, and for allowing the power tools and/or the spraying nozzles to be driven or operated by the pneumatic or hydraulic power driving apparatus with different driving power or forces.

In accordance with one aspect of the invention, there is provided a three way coupler comprising a housing including a bore formed therein for receiving fluid therethrough, and including two ends for pipe coupling purposes, and including an aperture formed therein and communicating with the bore of the housing, a barrel including a first end engaged into the aperture of the housing, and secured to the housing, and having a valve seat provided in the first end thereof, and including a hole formed therein, and communicating with the bore of the housing, and including a passage formed therein and communicating with the hole of the barrel, and a first adjusting device including a stem slidably engaged into the hole of the barrel, and including a plug movable relative to the valve seat of the barrel, to adjust a flowing of the fluid through the passage of the barrel.

The stem includes a rod extended therefrom and having an outer diameter smaller than an inner diameter of the hole of the barrel, to form an annular space between the rod and the barrel, and to communicate with the passage of the barrel. The plug is disposed on the rod, and includes a sealing ring engaged thereon for engaging with the valve seat of the barrel. The stem includes a knob secured thereto, to rotate the stem relative to the barrel.

A securing device is further provided for securing the knob to the barrel, to maintain the plug in disengagement from the valve seat of the barrel. The securing device includes an outer thread formed on the barrel, and an inner thread formed in the knob to thread with the outer thread of the barrel, and to secure the knob to the barrel.

A biasing device is further provided for biasing the plug to engage with the valve seat of the barrel. The stem includes a knob secured thereto, the biasing device includes a spring engaged between the barrel and the knob, to force the plug to engage with the valve seat of the barrel.

A second adjusting device may further be provided and attached to the housing, to adjust a flowing of the fluid through the bore of the housing. The housing includes an orifice formed therein and communicating with the bore of the housing, the second adjusting device includes a shank rotatably engaged into the orifice of the housing and includes a passage formed in the shank for selectively aligning with the bore of the housing, to adjust the flowing of the fluid through the bore of the housing.

A positioning device may further be provided for positioning the shank to the housing. The shank includes a knob having a plurality of depressions formed therein, the positioning device includes a spring biased projection received in the housing, and selectively engageable into either of the depressions of the knob, to position the shank to the housing at selected angular position.

Two sealing rings may further be provided and engaged between the shank and the housing, to make a fluid-tight seal between the shank and the housing. A retaining ring may further be provided and attached to the shank, and engaged with the housing, to rotatably secure the shank of the second adjusting device to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a three way coupler in accordance with the present invention;

FIG. 2 is a perspective view of the three way coupler;

FIG. 3 is a cross sectional view taken along lines 3-3 of FIG. 2;

FIG. 4 is a cross sectional view similar to FIG. 3, illustrating the operation of the three way coupler;

FIG. 5 is a cross sectional view taken along lines 5-5 of FIG. 2; and

FIGS. 6, 7 are cross sectional views similar to FIG. 5, illustrating the operation of the three way coupler.

### DETAILED DESCRIPTION OF THE PREFERRED EMBODIMENT

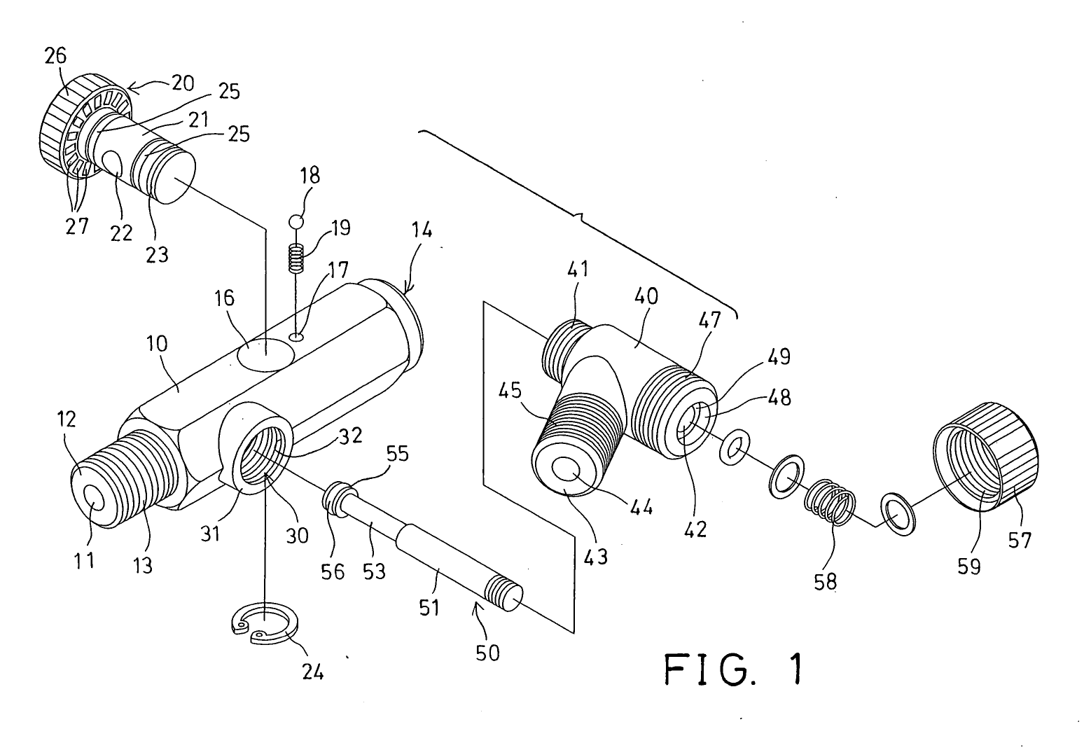

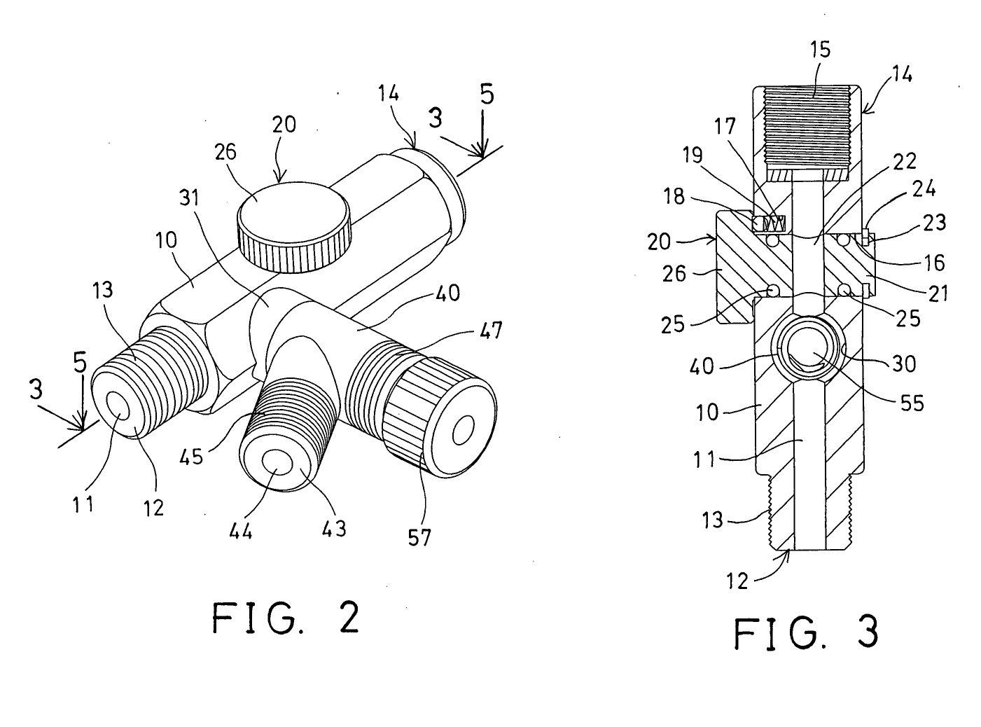

Referring to the drawings, and initially to FIGS. 1-3, a three way coupler in accordance with the present invention comprises a housing 10 including a bore 11 formed therein, and including one end 12 having an outer thread 13 formed therein, and including another end 14 having an inner thread 15 formed therein.

The outer thread 13 and the inner thread 15 of the housing 10 may be used for coupling to various kinds of power tools (not shown) or spraying nozzles (not shown) or for coupling to pneumatic or hydraulic power driving apparatuses (not shown) via conduits or pipes (not shown) or the like, and for allowing the power tools or the spraying nozzles or the like to be operated or driven by the pneumatic or hydraulic power driving apparatuses.

The housing 10 includes an orifice 16 formed therein, such as formed in the middle portion thereof, and preferably perpendicular to the housing 10, and communicating with the bore 11 of the housing 10, and further includes a cavity 17 formed therein, and located beside the orifice 16 of the housing 10, for receiving a spring biased projection which has a ball 18 and a spring 19.

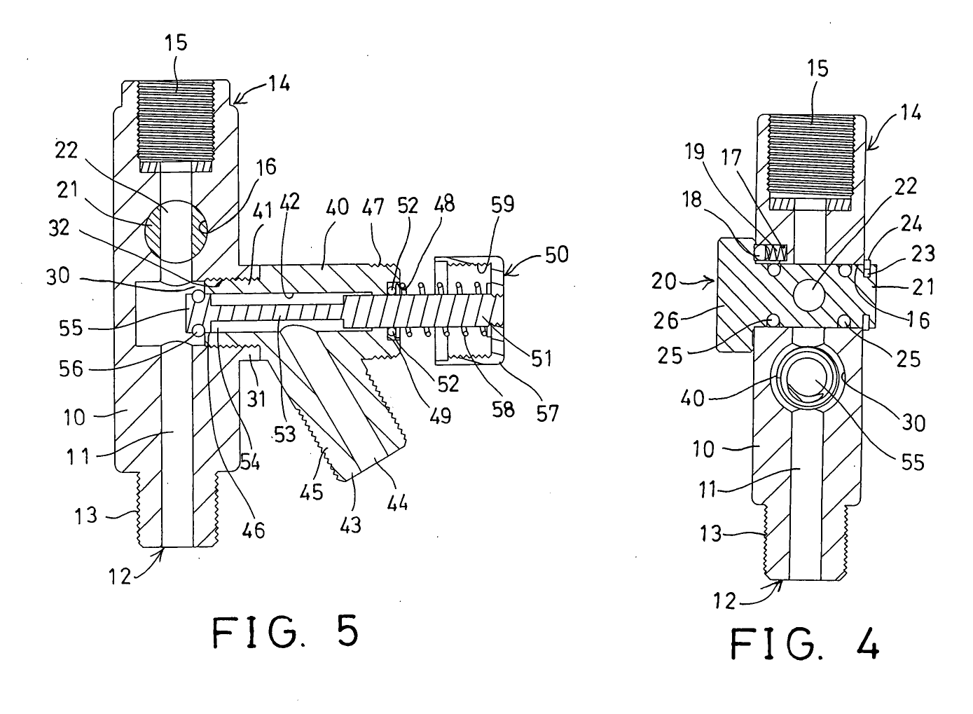

An adjusting device 20 includes a shank 21 rotatably engaged into the orifice 16 of the housing 10, a passage 22 formed in the shank 21, for selectively aligning with the bore 11 of the housing 10 (FIGS. 3, 4), and for controlling or adjusting the flowing of air or fluid through the bore 11 of the housing 10. The shank 21 includes an annular recess 23 formed in one end thereof, for receiving a retaining ring 24 (FIGS. 3, 4), which may be engaged with the housing 10 for rotatably securing the shank 21 of the adjusting device 20 to the housing 10.

Two sealing rings 25 are engaged onto the shank 21, and engaged with the housing 10, for making a water tight or air tight seal between the shank 21 of the adjusting device 20 and the housing 10, and thus for preventing air or fluid from flowing out through the orifice 16 of the housing 10. The shank 21 further includes a knob 26 formed or provided on one end thereof, for rotating the shank 21.

The knob 26 of the shank 21 includes a number of depressions 27 formed therein, for selectively receiving the spring biased ball 18, and thus for positioning the knob 26 and the shank 21 to the housing 10 at selected angular positions, and thus to position and maintain the relative positions between the passage 22 of the adjusting device 20 and the bore 11 of the housing 10 (FIGS. 3, 4).

In operation, as shown in FIGS. 3, 4, when the shank 21 is rotated relative to the housing 10 by such as the knob 26, the passage 22 of the adjusting device 20 may also be rotated or adjusted relative to the bore 11 of the housing 10, in order to adjust the flowing of the air or fluid through the bore 11 of the housing 10.

The housing 10 further includes an aperture 30 formed therein, such as formed in the middle portion thereof, and defined by a hub 31, and preferably perpendicular to the housing 10, and communicating with the bore 11 of the housing 10, and further includes an inner thread 32 formed therein, such as formed in the hub 31 of the housing 10.

A barrel 40 includes an outer thread 41 formed on one end thereof, for threading with the inner thread 32 of the housing 10, and for securing the barrel 40 to the housing 10; and includes a hole 42 formed therein, and communicating with the bore 11 of the housing 10. The barrel 40 further includes an outer thread 47 formed on the other end thereof, and a recess 48 formed in the other end thereof and communicating with the hole 42 thereof, and having an outer diameter greater than that of the hole 42 thereof to form a peripheral shoulder 49 in the other end thereof.

The barrel 40 further includes a manifold 43 extended therefrom and having a passage 44 formed therein and communicating with the hole 42 of the barrel 40. The manifold 43 includes an outer thread 45 formed on one end thereof, for coupling to various kinds of power tools (not shown) or spraying nozzles (not shown) or for coupling to pneumatic or hydraulic power driving apparatuses (not shown) via conduits or pipes (not shown) or the like.

Another adjusting device 50 includes a stem 51 rotatably engaged into the hole 42 of the barrel 40, a sealing rings 52 engaged onto the stem 51 and engaged with the barrel 40, for making a water tight or air tight seal between the stem 51 of the adjusting device 50 and the barrel 40, and thus for preventing air or fluid from flowing out through the hole 42 of the barrel 40.

The stem 51 further includes a rod 53 extended therefrom and extendible out of the hole 42 of the barrel 40, and extendible into the aperture 30 of the housing 10. The rod 53 includes an outer diameter smaller than that of the stem 51 or smaller than the inner diameter of the hole 42 of the barrel 40, to form an annular space 54 between the rod 53 and the barrel 40 (FIGS. 5-7) and to communicate with the passage 44 of the barrel 40.

The stem 51 further includes a head 55 extended therefrom or provided on the inner or free end of the rod 53, and having another sealing ring 56 engaged thereon, for engaging with a valve seat 46 that is formed and provided in one end of the barrel 40 (FIGS. 5-7), and in order to control the water or fluid or pressurized air through the hole 42 and the annular space 54 of the barrel 40 and through the passage 44 of the barrel 40.

The stem 51 further includes a knob 57 provided or secured to one end thereof, for rotating the stem 51. A spring 58 may be engaged between the knob 57 and the barrel 40, and received or seated in the recess 48 or the peripheral shoulder 49 of the barrel 40, to bias the stem 51 out of the barrel 40, and to bias or force the head 55 and the sealing ring 56 to engage with the valve seat 46 of the barrel 40, and thus to control the water or fluid or pressurized air through the hole 42 and the annular space 54 of the barrel 40 and through the passage 44 of the barrel 40.

The knob 57 of the stem 51 includes an inner thread 59 formed therein, for threading with the outer thread 47 of the barrel 40 (FIG. 7), and for securing the knob 57 and the stem 51 to the barrel 40 at a selected angular position where the head 55 and the sealing ring 56 are disengaged from the valve seat 46 of the barrel 40, to allow the water or fluid or pressurized air to continuously flow out through the hole 42 and the annular space 54 of the barrel 40 and through the passage 44 of the barrel 40.

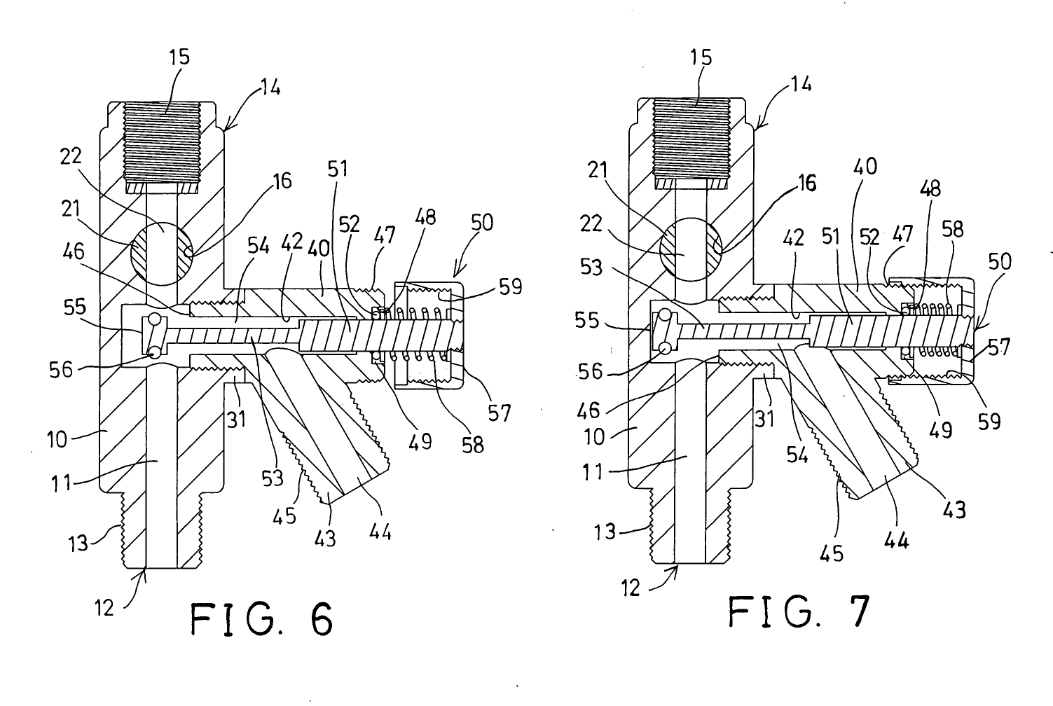

In operation, as shown in FIGS. 5 and 6, when the stem 51 is moved relative to the barrel 40 by such as the knob 57, the head 55 of the adjusting device 50 may also be moved or adjusted relative to the hole 42 and the valve seat 46 of the barrel 40, in order to adjust the flowing of the air or fluid through the passage 44 of the manifold 43 of the barrel 40. When the air or fluid is required to continuously flow out through the passage 44 of the manifold 43 of the barrel 40, the knob 57 may be threaded to the barrel 40, to secure the knob 57 and the stem 51 to the barrel 40, and to maintain the head 55 and the sealing ring 56 in disengagement from the valve seat 46 of the barrel 40.

The two ends 12, 14 of the housing 10 and the manifold 43 of the barrel 40 may be coupled to various power tools (not shown) or spraying nozzles (not shown) or pneumatic or hydraulic power driving apparatuses (not shown) via conduits or pipes (not shown) or the like, and for allowing the power tools and/or the spraying nozzles or the like to be simultaneously coupled to and driven by the pneumatic or hydraulic power driving apparatuses.

In addition, the adjusting devices 20, 50 may be used to adjust the flowing of the air or fluid through the bore 11 of the housing 10 and/or the passage 44 of the manifold 43 of the barrel 40, to allow the power tools and/or the spraying nozzles to be driven or operated by the pneumatic or hydraulic power driving apparatus with different driving power or forces.

Accordingly, the three way coupler in accordance with the present invention may be used for simultaneously coupling two or more power tools and/or spraying nozzles or the like to pneumatic or hydraulic power driving apparatuses, and includes one or more adjusting devices for adjusting the flowing of air or fluid through the conduits or pipes of the pneumatic or hydraulic power driving apparatuses, and for allowing the power tools and/or the spraying nozzles to be driven or operated by the pneumatic or hydraulic power driving apparatus with different driving power or forces.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A three way coupler comprising:
a housing including a bore formed therein for receiving fluid therethrough, and including two ends for pipe coupling purposes, and including an aperture formed therein and communicating with said bore of said housing,
a barrel including a first end engaged into said aperture of said housing, and secured to said housing, and having a valve seat provided in said first end thereof, and including a hole formed therein, and communicating with said bore of said housing, and including a passage formed therein and communicating with said hole of said barrel, and
a first adjusting device including a stem slidably engaged into said hole of said barrel, and including a plug movable relative to said valve seat of said barrel, to adjust a flowing of the fluid through said passage of said barrel.

2. The three way coupler as claimed in claim 1, wherein said stem includes a rod extended therefrom and having an outer diameter smaller than an inner diameter of said hole of said barrel, to form an annular space between said rod and said barrel, and to communicate with said passage of said barrel.

3. The three way coupler as claimed in claim 2, wherein said plug is disposed on said rod, and includes a sealing ring engaged thereon for engaging with said valve seat of said barrel.

4. The three way coupler as claimed in claim 1, wherein said stem includes a knob secured thereto, to rotate said stem relative to said barrel.

5. The three way coupler as claimed in claim 4 further comprising means for securing said knob to said barrel, to maintain said plug in disengagement from said valve seat of said barrel.

6. The three way coupler as claimed in claim 5, wherein said securing means includes an outer thread formed on said barrel, and an inner thread formed in said knob to thread with said outer thread of said barrel, and to secure said knob to said barrel.

7. The three way coupler as claimed in claim 1 further comprising means for biasing said plug to engage with said valve seat of said barrel.

8. The three way coupler as claimed in claim 7, wherein said stem includes a knob secured thereto, said biasing means includes a spring engaged between said barrel and said knob, to force said plug to engage with said valve seat of said barrel.

9. The three way coupler as claimed in claim 1 further comprising a second adjusting device attached to said housing, to adjust a flowing of the fluid through said bore of said housing.

10. The three way coupler as claimed in claim 9, wherein said housing includes an orifice formed therein and communicating with said bore of said housing, said second adjusting device includes a shank rotatably engaged into said orifice of said housing and includes a passage formed in said shank for selectively aligning with said bore of said housing, to adjust the flowing of the fluid through said bore of said housing.

11. The three way coupler as claimed in claim 10 further comprising means for positioning said shank to said housing.

12. The three way coupler as claimed in claim 11, wherein said shank includes a knob having a plurality of depressions formed therein, said positioning means includes a spring biased projection received in said housing, and selectively engageable into either of said depressions of said knob, to position said shank to said housing at selected angular position.

13. The three way coupler as claimed in claim 12 further comprising two sealing rings engaged between said shank and said housing, to make a fluid-tight seal between said shank and said housing.

14. The three way coupler as claimed in claim 10 further comprising a retaining ring attached to said shank, and engaged with said housing, to rotatably secure said shank of said second adjusting device to said housing.
